(19) United States
(12) Patent Application Publication
(10) Pub. No.: US 2018/0077324 A1
(43) Pub. Date: Mar. 15, 2018

(54) SURVEILLANCE FLAG POLE

(71) Applicant: John B. Adrain, Frisco, TX (US)

(72) Inventor: John B. Adrain, Frisco, TX (US)

(21) Appl. No.: 15/702,954

(22) Filed: Sep. 13, 2017

Related U.S. Application Data
(60) Provisional application No. 62/393,784, filed on Sep. 13, 2016.

(51) Int. Cl. H04N 5/225; H04N 7/18; H04N 5/232; E04H 12/18

(52) U.S. Cl. CPC H04N 5/2253; H04N 7/183; H04N 5/23203; G08B 15/001; H04N 5/23296; E04H 12/182; H04N 5/2256

(57) ABSTRACT

A security system configured with a flagpole to monitor a region in view of the flagpole, such a system having a camera and optionally one or more sensors mounted on the flagpole and optionally using computer system for controlling the system.

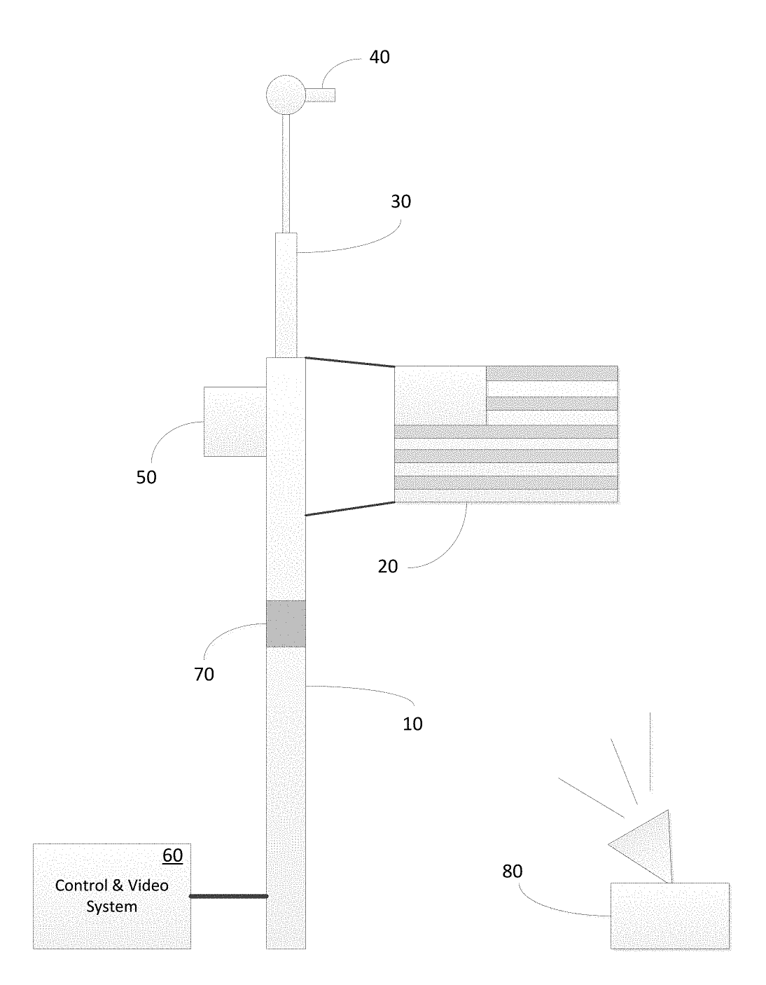

### CROSS-REFERENCES TO RELATED APPLICATIONS

This application claims the benefit of U.S. provisional application Ser. No. 62/393,784 that was filed on Sep. 13, 2017 and is hereby incorporated herein by reference

### BACKGROUND

Security concerns are common in residential and commercial locations, including government properties. Security systems that blend in with the surroundings but have good properties of access or viewpoint are desirable. Since flag poles are commonly found in both residential and commercial properties and are designed for wide viewing and relatively high heights, the use of such flag poles for security functions would be useful.

### SUMMARY

Provided are a plurality of example embodiments, including, but not limited to, a. security system comprising: a flagpole configured to display a flag; a camera mounted on the flagpole, said camera being configured to monitor a region surrounding the flagpole, said camera having zoom, pan, and motion capability; an extension system configured to adjust the location of the flag by remote control; and a control system for remotely controlling the camera and the extension system.

Also provided is a security system comprising: a flagpole configured to display a flag; a camera mounted on the flagpole above a location for a deployed flag, said camera being configured to monitor a region surrounding the flagpole, said camera having zoom, pan, and motion capability; an extension system configured to adjust the location of the flag by remote control; one or more sensors mounted on the flagpole; and a control system for remotely controlling the camera and the extension system based in inputs from the sensor(s).

Further provided is a security system comprising: a flagpole configured to display a flag; a camera mounted on the flagpole, said camera being configured to monitor a region surrounding the flagpole, said camera having zoom, pan, and motion capability; one or more sensors mounted on the flagpole configured to detect the presence and/or location of an intruder in the region; and a control system for remotely controlling the camera and the extension system based in inputs from the sensor(s) and the camera.

Also provided is a security system comprising: a flagpole configured to display a flag; a camera mounted on the flagpole above a location for a deployed flag, said camera being configured to monitor a region surrounding the flagpole, said camera having zoom, pan, and motion capability; an extension system configured to adjust the location of the flag by remote control; one or more sensors mounted on the flagpole configured to detect the presence and/or location of an intruder in the region; a high-intensity light source mounted on the flagpole to illuminate the region in response to detecting an intruder; and a control system for remotely controlling the camera and the extension system based in inputs from the sensor(s) and the camera, said control system configured to control the extension system and the high-intensity light source and the camera.

Further provided is a security system comprising: a flagpole configured to display a flag; a camera mounted on the flagpole, said camera being configured to monitor a region surrounding the flagpole, said camera having zoom, pan, and motion capability, wherein said camera is hidden and mounted on top of the flagpole; and a control system for remotely controlling operation of the camera.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

The figure shows an example embodiment of a security system used as a flag pole.

### DETAILED DESCRIPTION OF THE EXAMPLE EMBODIMENTS

Flag poles are commonly found in both residential, governmental, and commercial locations, and hence modifying a flag pole to provide security functions would be a discrete way of adding such security functions to such properties.

The figure shows an example embodiment of a flag pole including security features. A flag pole 10 for displaying a flag 20 is provided. This example flag pole has an added, but optional, telescoping region 30 on which a security camera 40 can be mounted. The telescoping region is provided in a manner such that the security camera 40 can be raised for a better viewing position and to avoid interference with the flag. This camera can be a digital camera such as a typical PTZ security camera, for example, or any desired type of camera, such as infrared, for example. The camera may be apparent from view, or camouflaged in the ball tip of the flagpole, for example.

Miniaturization of cameras make it easier to hide the camera from view, but in some situations a visible camera is useful to deter criminal activity, and in some situations the visible camera might be a non-functional decoy.

Alternatively, the camera can be embedded in a transparent “ball” of the flagpole, with the ball being coated in a material that acts as a one-way mirror or otherwise camouflages the camera so that it is not apparent. This can be similar to some of the camera systems used in security monitoring, where the camera is placed behind a mirrored ball or window.

As another alternative, the camera could be provided on a track within or outside the ball. In any case, the camera, where functional, preferably would be structured to provide a good view of the area surrounding the flagpole, such as through use of wide-angle cameras and tilt/pan/zoom/rotate functions, for example, that could be computer controlled in an automatic fashion, or manually controlled by a guard or other security or non-security person.

An extension system 50 is optionally provided to automatically extend the telescoping region when video surveillance is desired. This system can be comprised of an electric motor and worm gear, for example, or may use a hydraulic or pneumatic system, or cables or some other extension mechanism. The extension system 50 can be controlled by an external device such as a control & video system 60, which may be comprised of one or more computer systems to automatically control the camera and/or enhance the image. The telescoping region might extend the flagpole an additional 10 or 20 feet from the flag, for example, or another desirable amount.

The camera may have zoom, pan, rotation, tilt, and other capabilities that may also controlled by the system 60 so that the camera can observe a large region around the flagpole, or a smaller region if desired. Image processing might also be used, as well as night vision technologies, that can be controlled or enhanced by the system 60, which could operate using commercially available camera control and image enhancement software installed on a server or other computer system.

Optionally, additional sensors 70 can be provided on the flag pole, which could include motion detectors, heat sensors, light sensors, magnetic sensors, radar sensors, sonar sensors, sound sensors, image sensors, radar sensors, or other types of sensors to detect people and/or animals, and/or vehicles, for example, or other targets for surveillance. These sensors could be used to deploy the camera by extending the telescoping portion, and/or to help control the camera in a manner to locate people or other objects that are desired to be videoed, such as to follow the path of an intruder. The sensors can also be used to collect additional information about the perimeter of the protected property. These sensors 70 can also be controlled and interpreted by the system 60 such as using commercially available software, or custom software.

Hence, the system may have a camera that is stowed until intruders are sensed by the sensors, with the system then being deployed to monitor the intruders, once detected.

If there is an illuminating light 80 for illuminating the flag 20, the system 60 can be used to dim the light 80 to provide a better video image, or the light may be controlled in a manner to improve the image, such as by tracking the subjects being monitored by the video camera, for example.

Alternatively or additionally, a high-intensity light such as a spotlight may be provided on the pole, such as near the camera, to illuminate an area being monitored by the camera and/or act as a deterrent to an intruder. Such a light may be an LED light ring, for example, that may encircle the camera lens, or some other type of spotlight (e.g., incandescent) mounted on or near the camera or in another location along the flagpole. An infrared or ultraviolet, or even radar, emitting source could be used in place of, or in addition to, the light, such that its emission cannot be seen by the intruder but can be used to enhance the image taken by the camera or track the intruder using the sensors or camera, for example.

As an additional alternative, rather than using the telescoping system 50 to move the camera away from the flag, the flag might be automatically moved out of the way of the camera by such a system, such as by lowering the flag using the flag lowering/raising mechanism or using (e.g., dyneema) tethers to move the flag out of the way via remote control (such as by the control system 60 or some other system). The movement of the flag could be provided in response to the movement or location of an intruder, for example, to help maintain tracking of the intruder.

The system 60 can be comprised of one or more computers, and can utilize off-the-shelf components and software and/or customized components and software as is known in the security arts. The system may also include one or more input devices, such as keyboards and/or touchscreens and/or a computer mouse for accepting command and control inputs from one or more users, and it may include one or more displays to display information and/or video images and/or alarm conditions obtained from the camera and/or sensors.

The system 60 may communicate with other components by wired connection, or by wireless communication, for example, and the system 60 may be provided remotely from the other components of the flagpole system.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A security system comprising:
a flagpole configured to display a flag;
a camera mounted on the flagpole, said camera being configured to monitor a region surrounding the flagpole, said camera having zoom, pan, and motion capability;
an extension system configured to adjust the location of the flag by remote control; and
a control system for remotely controlling the camera and the extension system.

2. The system of claim 1, wherein said extension system can lower or raise the flag on a fixed flagpole.

3. The system of claim 1, wherein said extension system can raise or lower the camera by extending or contracting the flagpole.

4. The system of claim 1, further comprising one or more sensors mounted on the flagpole for use by the control system for detecting and/or tracking an intruder.

5. The system of claim 4, wherein said sensor is a motion detector.

6. The system of claim 4, wherein said sensor is a sonar or radar detector for monitoring the region.

7. The system of claim 4, wherein said sensor is a sound detector for monitoring sound in the region.

8. The system of claim 1 further comprising a light source located on the flagpole for illuminating a region monitored by the camera.

9. The system of claim 8, wherein said light source is a high-intensity light source mounted above the location of a deployed flag.

10. The system of claim 1, wherein the camera is mounted on the flagpole above a location for a deployed flag.

11. A security system comprising:
a flagpole configured to display a flag;
a camera mounted on the flagpole above a location for a deployed flag, said camera being configured to monitor a region surrounding the flagpole, said camera having zoom, pan, and motion capability;
an extension system configured to adjust the location of the flag by remote control;
one or more sensors mounted on the flagpole; and
a control system for remotely controlling the camera and the extension system based in inputs from the sensor(s).

12. The system of claim 11, wherein said extension system can lower or raise the flag on a fixed flagpole.

13. The system of claim 11, wherein said extension system can raise or lower the camera by extending or contracting the flagpole.

14. The system of claim 11, wherein said sensor is a motion detector.

15. The system of claim 11, wherein said sensor is a sonar or radar detector for monitoring the region.

16. The system of claim 11, wherein said sensor is a sound detector for monitoring sound in the region.

17. The system of claim 11 further comprising a high-intensity light source located on the flagpole for illuminating the region monitored by the camera.

18. A security system comprising:
a flagpole configured to display a flag;
a camera mounted on the flagpole, said camera being configured to monitor a region surrounding the flagpole, said camera having zoom, pan, and motion capability;
one or more sensors mounted on the flagpole configured to detect the presence and/or location of an intruder in the region; and
a control system for remotely controlling the camera and the extension system based in inputs from the sensor(s) and the camera.

19. The security system of claim 18, wherein said camera is hidden and mounted above a location for a deployed flag.

20. The security system of claim 19, wherein the cameral is hidden in a ball device mounted on top of the flagpole.

21. A security system comprising:
a flagpole configured to display a flag;
a camera mounted on the flagpole above a location for a deployed flag, said camera being configured to monitor a region surrounding the flagpole, said camera having zoom, pan, and motion capability;
an extension system configured to adjust the location of the flag by remote control;
one or more sensors mounted on the flagpole configured to detect the presence and/or location of an intruder in the region;
a high-intensity light source mounted on the flagpole to illuminate the region in response to detecting an intruder; and
a control system for remotely controlling the camera and the extension system based in inputs from the sensor(s) and the camera, said control system configured to control the extension system and the high-intensity light source and the camera.

22. A security system comprising:
a flagpole configured to display a flag;
a camera mounted on the flagpole, said camera being configured to monitor a region surrounding the flagpole, said camera having zoom, pan, and motion capability, wherein said camera is hidden and mounted on top of the flagpole; and
a control system for remotely controlling operation of the camera.

23. The security system of claim 22, wherein the cameral is hidden in a ball device mounted on top of the flagpole.
